(19) United States
(12) Patent Application Publication
(10) Pub. No.: US 2008/0293438 A1
(43) Pub. Date: Nov. 27, 2008

(54) METHOD OF USE FOR A QUICK PAGING SYSTEM

(75) Inventor: John M. Harris, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/751,691

(22) Filed: May 22, 2007

(51) Int. Cl. H04Q 7/20

(52) U.S. Cl. 455/458

(57) ABSTRACT

A method and apparatus of a waking up a communication unit (102-104) from a sleep mode is disclosed. The method includes determining the power resources of a communication unit. The communication unit monitors a quick paging channel and a paging channel when the power resources of the communication unit a below a threshold and the communication unit monitors only the paging channel received by the communication unit with the power resources of the communication unit is above the threshold or has a constant power source.

### FIELD OF THE INVENTION

The present invention relates generally to the field of wireless communications and, more particularly, to a method of use of a paging channel and a quick paging channel.

### BACKGROUND

Many battery powered communication units have a sleep, or idle, mode in which they are able to conserve power by powering down components such as their receivers. In the sleep mode, a communication unit is not on a traffic channel and it conserves power by periodically checking for incoming message. These communication units then “wake up” periodically to determine if any messages (pages) are going to be transmitted to them. If there are no messages that the communication unit needs to receive, it will power down in order to extend its battery life. Next generation Code-Division Multiple-Access (CDMA) cellular communication systems, more commonly referred to as CDMA 2000 or Wideband CDMA systems, also known as Universal Mobile Telecommunication System (UMTS), incorporate such power saving techniques. Each communication unit within a CDMA 2000 system is normally able to determine to which group of four, 20 millisecond (ms), synchronous frames on its paging channel (PCH) it is assigned. This group of frames, referred to as its “paging slot,” is used by the infrastructure to transmit messages to the particular unit. Thus, a communication unit in so-called “slotted mode” operation exits its sleep mode in order to monitor transmissions associated with its assigned paging slot. The faster a communication unit can determine that it has no messages or no more messages to receive, the faster it can return to sleep mode and conserve power, further extending its battery life.

CDMA 2000 also incorporates a Quick Paging Channel (QPCH) to reduce the time a communication unit must monitor the PCH. QPCH information is transmitted 100 ms earlier than the corresponding PCH slot. A couple of paging indicator bits are transmitted in the QPCH slot that tell each communication unit whether it may be addressed by any of the upcoming PCH messages. Because the QPCH does not employ error correction coding or interleaving as the PCH does, the time required for a communication unit to receive and process its bits is small compared to the time required to monitor the PCH slot. Thus, the QPCH allows communication units to determine whether they need to monitor the upcoming corresponding PCH slot at all. Normally, a large number of communication units determine, based on the QPCH indicators, that they do not need to monitor the PCH during the upcoming corresponding slot and they can rapidly re-enter a “sleep mode,” where battery power is conserved.

The use of QPCH and PCH is an example of a two phase paging system that is included in CDMA 2000, UMTS, HRPD, 802.16e and WiMAX communication systems. During the first phase, a shorter more ambiguous message or messages is sent to users. The purpose of this message is to quickly inform a large fraction of communication units that there is no page for them. The remaining users, which during the first phase are not sure if they are being paged, additionally must monitor the information received and the second phase of the paging message. Based on the information in the second phase of the paging message, the mobile can determine if it is being paged. The second phase of the paging message is not ambiguous. At this point, all mobiles which are not being paged should be able to go to sleep. Mobiles which are being paged typically need to respond or perform some subsequent activity. Throughout this application, when the term QPCH is used, it is used to refer to the first phase of a two-phased page in any such two-phased paging system. When they PCH message or slot is mentioned, it is effectively referring to the second phase of a two-faced page in any such two-phased paging system.

Even though there are communication units that do determine, based on the QPCH indicators, that they do not need to monitor the PCH during the upcoming corresponding slot, there are other communication units that do monitor the PCH. These communications units wake up upon the receipt of the QPCH indicator because the couple of bits that make up the QPCH indicator match the corresponding bits for those communication units' identification. For the units which match, they then monitor the PCH where the full identification of the communication unit that is being paged is sent. In some circumstances, the identification sent over the PCH matches the identification of the communication unit that woke up after the QPCH indicator was received. In other circumstances, the identification sent over the PCH does not match the identification of the communication unit that woke up after the QPCH indicator was received. These units then return to sleep mode. During the time that communication unit was awake, between the receipt of the QPCH indicator and the PCH, battery life is being consumed unnecessarily. This is known by those of skill in the art as falsing.

Thus, a communication unit, a communication infrastructure, and method that reduce the number of times that a communication unit wakes up in response to the page sent over the QPCH is needed to save battery life are needed. In addition, the need exists to reduce the number of falsings for communication units.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram depiction of a communication system in accordance with some embodiments of the invention.

FIG. 2 is a block diagram of listening mode indicators used in accordance with some embodiments of the invention.

FIG. 3 is a logic flow diagram of steps executed by a communication infrastructure in accordance with one embodiment of the present invention.

FIG. 4 is a logic flow diagram of steps executed by a communication unit in accordance with another embodiment of the present invention.

FIG. 5 is a logic flow diagram of steps executed by a communication unit in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps related to the use of the quick paging channel under given circumstances such as when a communication unit has sufficient power resources from a battery or a constant power source. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,”“comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of related to the use of the QPCH under proscribed power resources described herein. The non-processor circuits may include, but are not limited to, a radio receiver, a radio transmitter, signal drivers, clock circuits, power source circuits, and user input devices. As such, these functions may be interpreted as steps of a method to perform related to the use of the QPCH under given power conditions. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

To address the need for a communication unit, a communication infrastructure and method that reduces the number of pages sent over the QPCH to which the communication unit responds, a listening mode indicator is provided where the indicator determines whether the communication unit should respond to the QPCH indicator that is sent and for the communication infrastructure to send a QPCH indicator to a communication unit that will unlikely wake up because of the given conditions of the communication unit. The listening mode indicator may be set so that the communication unit does not respond for a given number of QPCH indicators received by the communication unit. In an embodiment, the communication unit does not respond to the QPCH under given circumstances including when the communication unit has sufficient battery resources or when the communication unit is plugged into a constant AC power source.

Falsings for communications units can be reduced by controlling when QPCH indicators are sent between the communication infrastructure and the communication units or are monitored by the communication units. As mentioned above, a QPCH indicator does not need to be sent under all circumstances, e.g. for certain types of service and in given geographical zones. In these situations, the communication infrastructure can send QPCH indicators when it is known that the communication units will wake up regardless of whether a QPCH and PCH indicator has been sent. Thus, falsings can be reduced if the communication infrastructure sends QPCH indicators for types of services and in zones of services at given intervals. By reducing the number of QPCH indicators being sent to communication units not needing or looking for the indicators, the communication units that would have falsed on the indicator will not occur. In addition, falsing can be reduced by determining that the communication unit does not have to monitor QPCH under given circumstances such as when there is a constant power source so that the battery resources pass a given threshold.

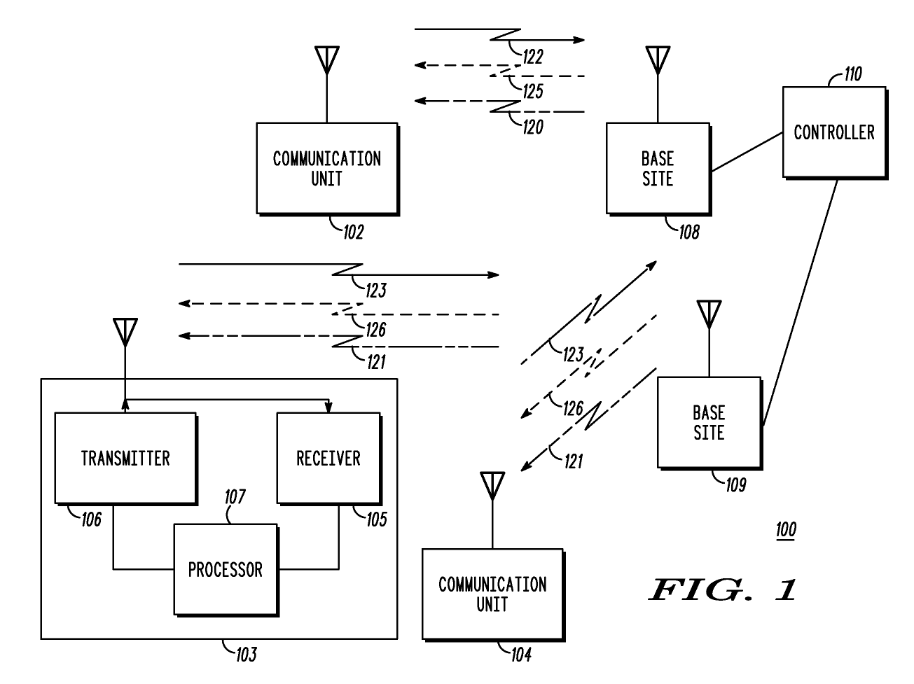

The present invention can be more fully understood with reference to FIGS. 1-5. FIG. 1 is a block diagram depiction of communication system 100 in accordance with an embodiment of the present invention. Communication system 100 is a system in accordance with the well-known Telecommunications Industry Association/Electronic Industries Association Interim Standard 2000 (TIA/EIA IS-2000 or CDMA 2000) modified as described below to implement the present invention. The principles of the present invention also apply to other communication systems such as UMTS, 802.16e and WiMAX systems and the like.

System 100 comprises fixed network equipment and mobile communication units. The fixed network equipment, or communication infrastructure, includes base sites 108 and 109 and controller 110 that are preferably networked to other base sites, controllers, and switches, all part of the fixed network equipment of system 100. For simplicity, only base sites 108 and 109 and controller 110 of the fixed network equipment is shown in FIG. 1. Again for simplicity, only three of what could be thousands of mobile communication units are shown in FIG. 1. Communication units 102-104 each preferably comprise CDMA-capable wireless phones that receive communications from base sites 108 and 109 via a CDMA air interface. Communication resources 120 and 121 each comprise a paging channel (PCH) of base sites 108 and 109, respectively. Communication resources 125 and 126 each comprise a quick paging channel (QPCH) of base sites 108 and 109, respectively. Lastly, communication resources 122 and 123 each comprise an access channel (ACH) of base sites 108 and 109, respectively.

Each of the communication units 102-104 comprises a common set of elements, a transmitter, a receiver, and a processor. In particular, processor 107 comprises one or more processing devices (e.g., microprocessors, digital signal processors, etc.) and memory devices and is coupled to transmitter 106 and receiver 105. Each of these elements is well-known in the art. In the preferred embodiment, under the control of software algorithms stored in the memory devices of processor 107 and in cooperation with the other elements shown, the processor 107 performs those tasks required for operation of communication unit 103, including the method described relative to the present invention.

Base sites 108 and 109 and controller 110 also comprise elements transmitters, receivers, and processors. Under the control of software algorithms stored in the memory devices of base sites 108 and 109 and controller 110, the communication infrastructure performs those tasks required for operation, including the method described below. While depicted as a separate box in FIG. 1, the physical implementation of controller 110 may take many forms. For example, the logical control functions performed by controller 110 may be physically distributed among processors on multiple physical platforms, physically distributed among the processors of the base sites, or physically performed by a processor on a single physical platform.

Operation of communication system 100 occurs substantially as follows. Controller 110 instructs base sites 108 and 109 to transmit an indication that the communication infrastructure will transmit a page addressed to at least one communication unit of a group of communication units in a paging slot but that does not indicate specifically which communication unit will be addressed. This indication is transmitted via QPCHs 125 and 126. Alternatively, however, this indication may take the form of the first frame of a partial address comparison message that, unlike an indication transmitted via a QPCH, is encoded, interleaved, CRC-protected, and transmitted on either forward common control channels or PCHs 120 and 121. In an embodiment in which a QPCH indication is transmitted, the group of communication units indicated is a paging hash group. Each such paging hash group is comprised of the communication units whose hashed IDs produce the same result.

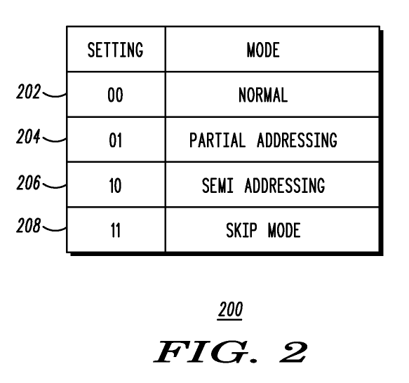

Receiver 105 receives the indication on the QPCH that base site 109 will transmit, in the corresponding paging slot, a page on the PCH addressed to one or more communication units in a paging hash group. Referring to FIG. 2, a listening mode indicator 200 is a part of the QPCH page. As will be appreciated by those of skill in the art, a similar listening mode indicator 200 can be included using partial address comparison. The listening mode indicator 200 includes a number of settings to inform the communication units about the QPCH indicator, how to respond to the QPCH indicator as well as information about the PCH and the PCH data. In the embodiment shown in FIG. 2, the listening mode indicator 200 has two bits so that the combination of the bits allows for four different settings.

When listening mode indicator 200 is set to a first setting 202, the QPCH indicator is in the normal mode. In this normal mode, the base sites 108, 109 will send a paging hash group to communication units 102-104 in the communication system 100 over the QPCHs 125, 126. The paging hash group is set up of partial addresses of communication units within the system 100 that will be receiving a page on the PCH 122, 123. Communication units 102-104 may be identified by the QPCH indicators in the paging hash group, but there may not be a communication unit receiving a page over the PCH 122, 123. The communication units 102-104 that have partial addresses that match the partial addresses in the paging hash group will wake up from a sleep mode upon receipt of the QPCH indicator. The communication units that have woken up then await the receipt of the page on the PCH. If the full address of the page on the PCH matches the communication unit's address, then that communication unit stays in the wake mode. On the other hand, the communication unit returns to the sleep mode when the full address does not match an address in the PCH page.

The communication units 102-104 use partial addressing when the listening mode indicator is set to a second setting 204. As with the first setting 202, a communication unit 102-104 returns to the sleep mode if its partial address does not match any of the hashes sent in the paging hash group unless a hash skip counter has been exceeded. If the hash skip counter has been exceeded then the communication unit stays in a wake mode during the PCH but does not monitor the QPCH. If the communication unit detects a hash match, then it continues to listen on the PCH for a paging message. The PCH message gives additional refinement to the paging received over the QPCH. Thus, if it any stage, the communication unit detects a mismatch between its address and the address received over the QPCH and PCH it returns to the sleep unless the hash skip counter has been exceeded.

As seen in FIG. 2, the listening mode indicator 200 also has a third setting 206 for a semi-addressing mode in the QPCH channel. In this mode, the QPCH indicator indicates the communication unit 102-104 using a smaller sized hash than the hashes used in normal and partial addressing modes. The QPCH then spells out larger hashes or the specific hash for the communication units 102-104 separately at the end. Thus, if a communication unit 102-104 notices that there is no match to the small hashes and as the hashes increase in size, it returns to the sleep mode unless the hash skip counter has be exceeded. If the has skip counter has been exceeded, the communication stays in the awake mode during the PCH slot.

When the listening mode indicator is set to the first setting 202, second setting 204 or third setting 206, the QPCH indicator includes an action code (not shown) to indicate to the communication unit 102-104 the paging action instruction of the communication unit. One action code requires that the communication unit 102-104 take no action other than for the communication unit to listen to the whole paging interval. Another code instructs the communication unit 102-104 to establish location with the communication infrastructure and to acknowledge the QPCH message. Yet another code, instructs the communication unit 102-104 to enter the network and to establish a communication channel.

Referring still to FIG. 2, the listening mode indicator includes a fourth setting 208 for the skip mode indicator of the present invention. When the skip mode indicator is set, the QPCH indicator includes the addresses of the communication units 102-104 for which the skip mode indicator applies. In an embodiment of the skip mode indicator, the addresses of the communication units 102-104 are complete addresses of the units so that it is clear which units are to be in this mode. A skip mode flag is also included as a part of the listening mode's skip mode. The skip mode flag can be one bit in the message where a value of 1 indicates that the specific communication unit 102-104 addressed is to enter the skip mode. A skip mode value of 0 indicates that the specific communication unit 102-104 is to exit the skip mode previously entered and to return to the listening mode having the first, second or third setting 202-206.

When the skip mode is entered, the skip mode sets a skip period which establishes the interval or period during which the communication unit 102-104 skips, or does not respond, to paging over the QPCH. In one embodiment, the skip mode period is set to the number of paging frames during which the communication unit does not respond to paging over the QPCH 125, 126. The skip mode also sets a skip offset. The skip offset is the specific offset during the skip period of the paging interval for the communication unit 102-104 to skip the QPCH but directly monitor the PCH. In other words, the communication unit skips the QPCH paging if skip offset match holds for the paging interval within the skip period.

In view of the foregoing, the skip mode indicates to the communication unit 102-104 that every given number equivalent to the skip offset within the skip period that the communication unit does not wake up on the receipt of the QPCH but instead always checks the page received on the PCH. By not checking the QPCH during the skip offset, falsing for the communication units 102-104 is reduced or eliminated. Falsing is reduced but the communication unit will still respond when necessary to a full page over the paging channel. The amount of battery resources that are conserved can be monitored by adjusting the skip period and the skip offset of the communication unit. In another embodiment, such as when battery resources for the communication unit is above a given threshold or there is a constant power resource, the skip mode can be used to reduce falsing and the complexity of messaging. The communication unit can return to using and monitoring the QPCH when the battery resources go below the threshold or there is no longer a constant power resource.

In the skip mode, the communication infrastructure can control when the QPCH indicator is to be sent to the communication units 102-104. Without the skip mode, the communication infrastructure established page hashing groups of communication units to which a page over the PCH was to be sent. The page hashing groups were created regardless of conditions of the communication unit, the type of messages being sent or considerations of the location of the communication unit. When the skip mode is turned on, the communication infrastructure knows when the communication units in the skip mode will be using the PCH 120, 121 to indicate if a page is being sent and does not need to be alerted over the QPCH 125, 126 that a page will be sent. Thus, the communication infrastructure can send pages under given conditions during that given interval when the communication units 102-104 will be checking the PCH. By not sending as many pages over the QPCH for as many communication units, the number of falsings is reduced.

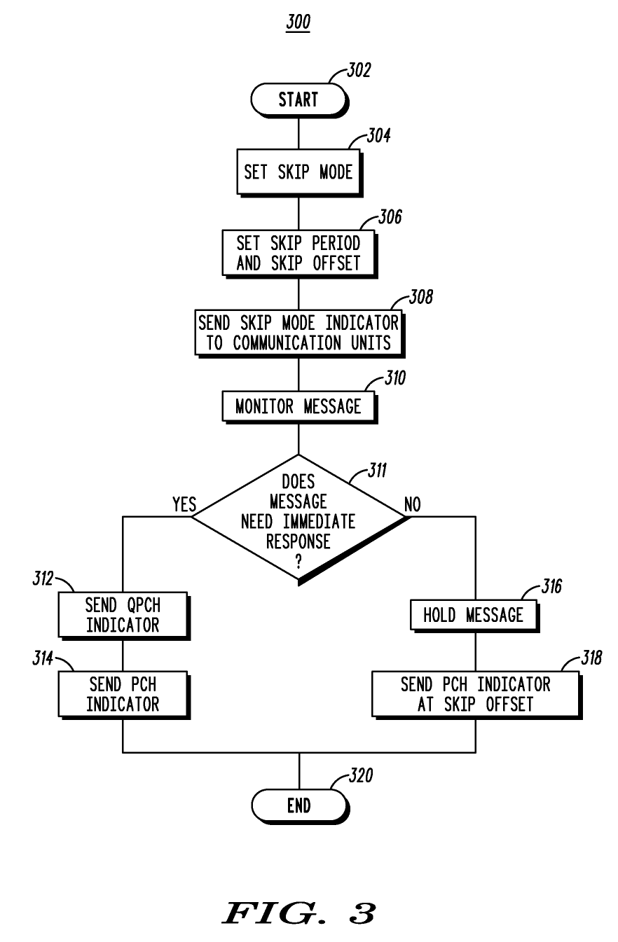

FIG. 3 is a logic flow diagram of steps executed by a communication infrastructure in accordance with an embodiment. In particular, FIG. 3 illustrates the operation of the communication infrastructure when the communication infrastructure monitors the types of messages and services being requested to determine when to send a QPCH indicator for a given communication unit 102-104 and when to skip sending QPCH indicators and to rely on waking up the unit with a PCH indicator. Logic flow 300 begins 302 when the infrastructure determines 304 that the listening mode for communication units within the communication system 100 should be set to the skip mode. This determination can be made when the communication infrastructure determines that battery resources for some or all of the communication units within the system 100 should be conserved. Alternatively, the skip mode can be used when the battery resources are strong enough that the QPCH does not provide any advantages and does not need to be used, such as when the communication unit has sufficient battery resources or is connected to a constant power source. The sufficient amount of battery resources can be determined by determining of the resources above or below a given threshold. This determination can be made when it detects that communication units 102-104 have low battery resources or for other reasons. When the determination has been made, the communication infrastructure sets 306 the skip period and skip offset for the communication units. The communication infrastructure sends 308 the skip period and skip offset to communication units 102-104 that are to be in the skip mode as a part of a listening mode indicator message. With the skip mode set and knowing the skip period and skip offset, the communication units in the skip mode know when it is not necessary to examine a QPCH 125, 126 sent and to wake up and to check the PCH 120, 121 regardless of whether the communication unit woke up because it is part of the page hashing group sent over a QPCH. The communication infrastructure also knows when the communication units 102-104 in the skip mode will wake up on receipt of a PCH even if that communication unit did not receive a QPCH indicator to wake up.

When the communication infrastructure and the communication units are in the skip mode, the communication infrastructure monitors 310 messages it receives that are to be sent to the communication units 102-104. These messages include call set-up messages to establish a communication channel between one of the communication units 102-104 and another communication unit (not shown) through the communication infrastructure. There are many types of call set-up messages and these messages include data that informs the communication infrastructure and the communication units of the type of services that will be sent. Such services include PTT calls, interconnect calls, text messages, such as email and SMS messages, video calls etc. A communication channel does not need to be established immediately for each type of communication service to operate properly. If it is determined that the message indicates a channel needs to set up immediately, such as for a PTT dispatch call, the communication infrastructure includes the intended communication unit as a part of the paging hash group that is typically sent 312 with the next QPCH message to the communication units 102-104. In another embodiment, a service shows up in the next paging opportunity that is a skip indicator, and the infrastructure will not use the QPCH indicator to notify the mobile of this incoming PTT service. A PCH indicator for the communication unit is then sent 314 after the QPCH indicator.

Alternatively, the communication infrastructure determines that a channel does not need to be set up immediately, such as for an email message, the communication infrastructure then holds 316 the message and can send the message to the intended communication unit at a later time. As the communication infrastructure and units are in the skip mode, it is known by the skip period and skip offset when the communication units 102-104 will skip the QPCH and will respond to messages sent during the PCH regardless of whether the communication unit wakes up in response to the QPCH indicator. Accordingly, the communication infrastructure sends 318 a message during the PCH to the communication unit at the given skip offset during the skip period. During the skip period, the communication infrastructure does not include the address of the communication unit in page hashing groups sent over the QPCH. It should be noted that it is not necessary to send a QPCH indicator during the skip offset because it is known that the communication unit will respond to the PCH at this interval. Logic flow 300 then ends 320.

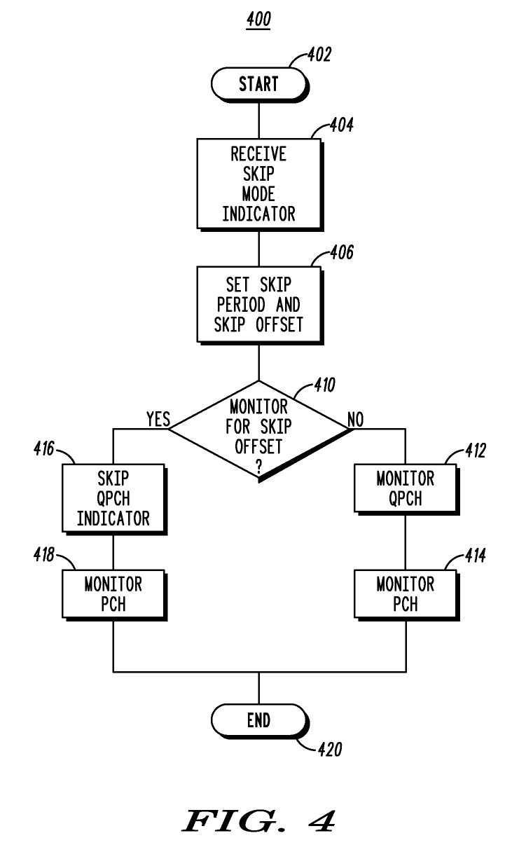

FIG. 4 is a logic flow diagram of steps executed by a communication unit in accordance with an embodiment of the present invention. Logic flow 400 begins 402 when it receives 404 a message that includes a skip mode indicator as a part of listen mode. The skip mode indicator sets 406 a skip period. The skip period can be based on the power resources of the communication unit such that the skip period is for as long as there battery resources are above a given threshold or there is a constant power resource. In an embodiment, the communication unit continues to monitor 408 the channel for the skip offset during the skip period. If a skip offset has not been reached, then the communication unit monitors 412 the QPCH and then monitors 414 is the PCH as is known. If the skip offset has been reached, the communication unit skips 416 monitoring the QPCH for a given interval based on the power resources of the communication unit and then monitors 418 the PCH channel to determine if a page is for the unit. The given interval to skip monitoring the QPCH, as mentioned, can be based on the battery and power resources of the communication unit. Provided that the battery resources are above the given threshold or there is a constant power resource, the communication unit can continue to skip monitoring the QPCH and only monitor the PCH. Logic flow 400 then ends at 420.

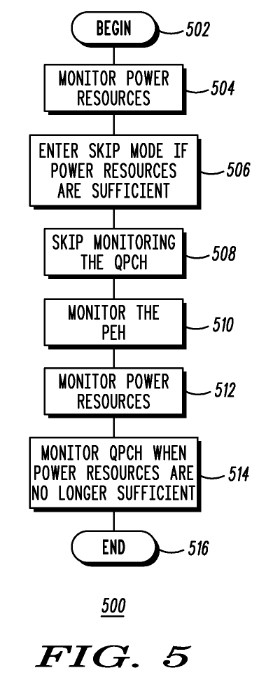

FIG. 5 is a logic flow diagram of steps executed by a communication unit in accordance with an embodiment of the present invention. Logic flow 500 begins 502 when it monitors 504 the power resources for the communication unit. If the battery power meets a given threshold thereby indicating that there is sufficient battery power for full operations of the communication unit or that battery resources do not have to be conserved, the communication unit enters 506 a skip mode. The communication unit can also enter the skip mode when it is connected to a constant power source such as being plugged into an AC power source. As described, the communication unit skips monitoring 508 the QPCH during the skip mode. The communication unit does monitor 510 the PCH during the skip mode so that when a message comes over the PCH the communication unit can respond appropriately. During the skip mode, the communication unit continues to monitor 512 its power resources. When the power resources goes below the threshold or when the is no longer a constant power source, the communication unit ceases operating 510 in the skip mode and returns to monitoring 514 the QPCH because the power resources are no longer sufficient such that advantages are provided by monitoring the QPCH. Logic flow 500 then ends at 516. In view of the foregoing, the communication unit controls under given circumstances when it will monitor the QPCH regardless of whether the communication infrastructure is utilizing or sending messages over the QPCH for that communication unit.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A method of a waking up a communication unit from a sleep mode, the method comprising:
receiving a first page wherein the first page indicates a group of communication units of which the communication unit may be a part and wherein one of the group of communication units receives a page;
receiving a second page wherein the full address page being the identifier of the one of the group of communication units to receive a page;
remaining in the sleep mode upon the receipt of the first page when the communication unit has a sufficient power resources, and
monitoring the second page and waking up the communication unit from the sleep mode upon the receipt of the second page.

2. The method of claim 1 wherein sufficient power resources comprises when the communication unit has a constant power resource.

3. The method of claim 1 wherein sufficient power resources comprises when the communication unit has power resources over a given threshold.

4. The method of claim 1 further comprising:
waking up the communication unit from the sleep mode upon the receipt of the first page when the communication unit no longer has the sufficient power resources.

5. The method of claim 4 wherein the communication unit no longer has the sufficient power resources when the power resources are below a given threshold.

6. The method of claim 4 wherein the communication unit no longer has the sufficient power resources when the communication unit relies on battery resources.

7. A method comprising:
determining the power resources of a communication unit;
monitoring a quick paging channel and a paging channel received by the communication unit when the power resources of the communication unit a below a threshold;
monitoring only the paging channel received by the communication unit with the power resources of the communication unit is above the threshold.

8. The method of claim 8 wherein the power resources of the communication unit is above the threshold when the communication unit has a constant power source.
